(19) United States
(12) Patent Application Publication
(10) Pub. No.: US 2010/0129719 A1
(43) Pub. Date: May 27, 2010

(54) NONAQUEOUS ELECTROLYTE SECONDARY BATTERY

(75) Inventors: Hirotomo Ito, Fukushima (JP); Keizo Koga, Fukushima (JP); Takashi Murakami, Fukushima (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/625,140

(22) Filed: Nov. 24, 2009

(30) Foreign Application Priority Data
Nov. 26, 2008 (JP) 2008-301208

(51) Int. Cl. H01M 4/62; B05D 5/12

(52) U.S. Cl. 429/232; 427/58

(57) ABSTRACT

A negative electrode mixture is provided and includes: a negative electrode active material containing a carbon based material; a binder containing at least a polyacrylonitrile based resin; and a polymer capable of suppressing an intermolecular interaction between cyano groups and imparting a steric hindrance.

### CROSS REFERENCES TO RELATED APPLICATIONS

The present application claims priority to Japanese Priority Patent Application JP 2008-301208 filed in the Japan Patent Office on Nov. 26, 2008, the entire content of which is hereby incorporated by reference.

### BACKGROUND

The present disclosure relates to a nonaqueous electrolyte secondary battery. In particular, the present disclosure relates to a negative electrode mixture having satisfactory adhesion to a collector and capable of displaying a high charge and discharge characteristic, a negative electrode and a nonaqueous electrolyte secondary battery including the subject negative electrode.

In general, an electrode to be used for lithium ion secondary batteries and the like has a structure in which an electrode material layer is provided on a collector made of a metal, etc. The electrode is generally manufactured by coating a coating solution having at least an active material and a binder dispersed or dissolved in a solvent on a collector and drying it. Such a manufacturing method is high in industrial productivity because an electrode with a large area is able to be manufactured at once.

When a carbon based active material is used as the negative electrode, polyvinylidene fluoride (PVDF), polyacrylonitrile (PAN), a styrene-butadiene rubber (SBR) and the like are widely used as the binder.

When a carbon based active material is used as the negative electrode, natural graphite or artificial graphite with high crystallinity is used from the standpoints of realization of a high capacity of the battery and the like. In natural graphite, though a capacity close to the theoretical capacity of graphite is obtained, its specific area is larger than that of artificial graphite; and when PVDF, SBR or the like is used as the binder, its binding properties to the negative electrode collector are often insufficient, resulting in problems such as a lowering of productivity and an increase of electrode failure rate. With respect to adhesion to the negative electrode collector, though the adhesion may be improved by increasing the addition amount of PVDF or SBR, inhibition of Li ion insertion at the time of charge or a lowering of the capacity is caused. On the other hand, in artificial graphite, since its specific surface area is generally lower than that of natural graphite, even when PVDF or the like is used as the binder, it is able to secure adhesion to the negative electrode collector, but its capacity is lower than that of natural graphite. By reducing the binder amount, though it is possible to realize a high capacity of the battery, adhesion to the negative electrode collector is lowered, resulting in problems such as a lowering of productivity and an increase of electrode failure rate.

On the other hand, when PAN is used as the binder, even with respect to natural graphite, adhesion to the negative electrode collector may be secured; and with respect to artificial graphite, even when the binder amount is reduced, adhesion to the negative electrode collector may be secured. Therefore, it becomes possible to realize a high capacity of the battery.

JP-T-2006-516795 discloses as follows.

“The invention relates to a negative electrode active material slurry for lithium secondary battery having enhanced dispersibility of a negative electrode active material and a conductive agent and to a lithium secondary battery containing the same. In more detail, the invention is characterized by adding a small amount of a dispersant including a polymer principal chain capable of being surface adsorbed and a side chain having characteristics of a nonionic surfactant to a negative electrode active material slurry including a carbon based negative electrode active material capable of intercalating and deintercalating a lithium ion, a binder containing a styrene-butadiene based polymer resin, a thickener containing a cellulose based or acrylate based resin and water.”

JP-A-2006-134777 discloses a positive electrode for lithium battery which does not cause a problem of a lowering of battery performance due to corrosion of a collector or the like and which is free from the generation of irregularities on the coated surface, by using a positive electrode formed of a positive electrode paste containing a specified positive electrode active material, a binder component composed of a water-dispersible elastomer and a water-soluble polymer as a thickener, water as a dispersion medium and a dispersant; and a lithium battery using the same.

JP-A-2003-331847 discloses that a nonaqueous secondary battery with excellent electric characteristics and capable of stably working even at a high temperature, which contains at least one kind of carbon materials having an average primary particle size of a positive electrode of from 10 to 100 nm, a binder such as polyvinylidene fluoride and a vinylidene fluoride-hexafluoropropane copolymer and a compound having a pyrrolidone skeleton and which has a degree of blackness of 1.20 or more, is provided; and that the manufacturing efficiency is enhanced by improving the storage stability of a coating material.

JP-A-2003-157846 discloses that a carbon black slurry for lithium secondary battery electrode prepared by using N-methyl-2-pyrrolidone as a dispersant, suspending therein carbon black having an average particle size of from 0.1 to 1 μm in a proportion of from 3 to 30% by mass and adding thereto from 0.1 to 10% by mass of a vinylpyrrolidone based polymer is provided; and that the carbon black slurry has a controllable particle size and satisfactory slurry stability with a lapse of time and handling properties such as measuring and transportation of the slurry and is capable of reducing a transportation cost by increasing its concentration.

JP-A-2004-63423 discloses that a coating solution for electrode manufacture with high viscosity stability and excellent production stability, which is a coating solution to be used for manufacturing a battery electrode, the coating solution containing a binder and a carbon based material in a solvent and further containing a polymer having a nitrogen-containing 5-membered ring structure in a side chain thereon in an amount of 1 ppm or more and not more than 10,000 ppm relative to the whole mass of the coating solution; and an electrode and a battery manufactured by using this coating solution are provided.

Now, when PAN is used as the binder, stability of the coating material is remarkably deteriorated, a solid content of the coating solution (mainly, a carbon based material) is coagulated, and after elapsing 2 to 10 hours, a hard sediment is formed in the bottom of a container so that coating may not be achieved. Even when coating is carried out immediately after manufacturing the coating solution, in view of the fact that the coating solution is coagulated with a lapse of time, distribution of the binder is generated in the coating solution, and adhesion to the negative electrode collector is deteriorated. Alternatively, faults such as a lowering of the capacity of a negative electrode due to scattering in the coating amount of the negative electrode, and stable coating may not be achieved. Thus, there was encountered such a serious problem that the productivity or electrode characteristics are remarkably lowered.

JP-A-2004-63423 is concerned with a technology for suppressing coagulation of a solid content or a lowering of viscosity of the coating solution by adding a polymer having a nitrogen-containing 5-membered ring structure in a side chain thereof to the coating solution, in which coagulation of the carbon based material occurred within a relatively short period of time after preparing the coating solution is suppressed, thereby suppressing clogging in a filter. The technology disclosed in JP-A-2004-63423 is, however, not concerned with suppression of coagulation derived from a polyacrylonitrile binder, e.g., the generation of a hard sediment in the bottom of a container after elapsing a relatively long period of time immediately after manufacturing the coating solution as in embodiments according to the present invention. When PVDF or a styrene-butadiene rubber is used as the binder, the foregoing coagulation does not take place.

Accordingly, it is desirable to provide a nonaqueous electrolyte secondary battery with excellent adhesion of a negative electrode mixture to a negative electrode collector and an excellent discharge capacity retention rate after repeated charge and discharge in a system using a polyacrylonitrile based resin as a binder, the subject negative electrode mixture, a negative electrode and a method for manufacturing a negative electrode.

### SUMMARY

It has been found that by adding a polymer capable of suppressing an intermolecular interaction between cyano groups and imparting a steric hindrance to a slurry, not only stability of the slurry is enhanced, but adhesion of a negative electrode mixture to a negative electrode collector is excellent.

According to embodiments, there are provided the following nonaqueous electrolyte secondary battery, negative electrode mixture, negative electrode and method for manufacturing a negative electrode.

[1] A nonaqueous electrolyte secondary battery including a negative electrode including a negative electrode collector and a negative electrode mixture laminated thereon, wherein the negative electrode mixture contains a negative electrode active material containing a carbon based material, a binder containing at least a polyacrylonitrile based resin and a polymer capable of suppressing an intermolecular interaction between cyano groups and imparting a steric hindrance.

[2] A negative electrode mixture including a negative electrode active material containing a carbon based material, a binder containing at least a polyacrylonitrile based resin and a polymer capable of suppressing an intermolecular interaction between cyano groups and imparting a steric hindrance.

[3] A negative electrode including a negative electrode collector and a negative electrode mixture laminated thereon, wherein the negative electrode mixture contains a negative electrode active material containing a carbon based material, a binder containing at least a polyacrylonitrile based resin and a polymer capable of suppressing an intermolecular interaction between cyano groups and imparting a steric hindrance.

[4] A method for manufacturing a negative electrode including the steps of coating a negative electrode mixture slurry on a negative electrode collector, the slurry containing a negative electrode active material containing a carbon based material, a solvent, a binder containing at least a polyacrylonitrile based resin and a polymer, the polymer being capable of suppressing an intermolecular interaction between cyano groups and imparting a steric hindrance; and after coating, removing the solvent of the negative electrode mixture slurry upon being evaporated.

In this specification, the “negative electrode mixture” means a mixture which is laminated on a negative electrode collector of a negative electrode to form a layer containing a negative electrode active material; and the “negative electrode mixture slurry” (hereinafter also referred to simply as “slurry”) means a negative electrode mixture formed in a slurry state for the purpose of being coated on a collector. Also, the polymer capable of suppressing an intermolecular interaction between cyano groups and imparting a steric hindrance is also referred to as “functional polymer according to an embodiment of the present invention”.

The functional polymer according to the embodiment is used together with a binder containing a polyacrylonitrile based resin. The functional polymer according to the embodiment is able to be adsorbed on a cyano group upon being polarized in the presence of a polyacrylonitrile based resin.

According to the embodiments, it is possible to provide a nonaqueous electrolyte secondary battery with a stable material quality because stability of the slurry is enhanced, coagulation of the slurry and generation of a sediment may be significantly delayed so that labor saving is attainable, and adhesion of the negative electrode mixture to the negative electrode collector is excellent.

Additional features and advantages are described herein, and will be apparent from the following Detailed Description and the figures.

### BRIEF DESCRIPTION OF THE FIGURES

FIG. 1 is a sectional view showing a configuration of a secondary battery according to an embodiment.

FIG. 2 is a sectional view showing enlargedly a part of a wound electrode body in the secondary battery shown in FIG. 1.

### DETAILED DESCRIPTION

Embodiments are hereunder described in detail. In this specification, the term “%” means a % by mass unless otherwise indicated.

In an embodiment, the functional polymer according to the embodiment is used for forming a negative electrode. The functional polymer according to the embodiment is hereunder described.

The functional polymer according to the embodiment has functions of preventing coagulation of a solid content of the slurry at the time of preparing a negative electrode and preventing the generation of a hard sediment in the bottom of a container. Reasons why the use of PAN as a binder causes the foregoing coagulation may be considered to reside in the following facts.

(1) PAN as a binder adsorbs on a carbon based material.

(2) PANs adsorbed on a carbon based material are intermolecularly bound to each other due to strong polarity of a cyano group.

(3) A carbon material drawn by PAN is coagulated.

Reasons why the use of the functional polymer according to the embodiment suppresses the foregoing coagulation may be considered to reside in the facts that the functional polymer adsorbs on a cyano group of PAN due to uneven distribution of charges within the molecule and that the contact of carbon materials with each other is suppressed due to a steric hindrance effect of the side chain of this polymer.

The functional polymer according to the embodiment has the foregoing functions.

Examples of the functional polymer having such functions according to the embodiment of the present invention include polyvinylpyrrolidone, polyethylene glycol, polyvinyl alcohol, polyacrylic acid, polyvinyl acetate, polymethyl acrylate, polymethyl methacrylate, polyethyl methacrylate, hydroxymethyl cellulose, polyacrylamide, starch and natural gum. The functional polymer according to the embodiment of the present invention may be used singly or in admixture of two or more kinds thereof.

A mass average molecular weight of the functional polymer according to the embodiment is preferably 1,000 or more and not more than 1,000,000, and more preferably 10,000 or more and not more than 500,000. When the molecular weight of this functional polymer is too low, a function as the steric hindrance effect may not be revealed. On the other hand, when the molecular weight is too high, there may be the case where solubility of the polymer is lowered, or a problem such as deterioration of productivity due to an increase of viscosity of the slurry, or an increase of electrode failure rate due to an inferior electrode shape, etc. is caused.

A total content of the functional polymer according to the embodiment is preferably from 0.01 to 5%, and more preferably from 0.01 to 2% on the basis of the whole mass of the negative electrode mixture. When the total content of this functional polymer falls within the foregoing range, the foregoing functions may be effectively displayed.

Next, the binder is described.

It is preferable that the binder contains a polyacrylonitrile based resin, or a polyacrylonitrile based resin and a polyvinylidene fluoride based resin.

The polyacrylonitrile based resin is preferably a homopolymer of (meth)acrylonitrile, a copolymer of (meth)acrylonitrile with other monomer, or a resin which is a modified product of the foregoing copolymer and which is a (meth)acrylate copolymer. Of these, a homopolymer of (meth)acrylonitrile is more preferable. In this specification, the “(meth)acrylonitrile” gives a general name to methacrylonitrile and acrylonitrile and means at least either one of them. The same is also applicable to the “(meth)acrylate”.

Examples of the copolymer of (meth)acrylonitrile with other monomer include copolymers of (meth)acrylonitrile with an alkyl (meth)acrylate (for example, methyl (meth)acrylate, ethyl (meth)acrylate, butyl (meth)acrylate, isobutyl (meth)acrylate, 2-ethylhexyl (meth)acrylate, lauryl (meth)acrylate, cyclohexyl (meth)acrylate, etc.), a cycloalkyl (meth)acrylate, a hydroxyalkyl (meth)acrylate (for example, 2-hydroxyethyl (meth)acrylate, 2-hydroxypropyl (meth)acrylate, etc.), an aminoalkyl (meth)acrylate (for example, aminomethyl (meth)acrylate, N-methylaminomethyl (meth)acrylate, N,N-diethylaminoethyl (meth)acrylate, etc.), methacrylic acid, acrylic acid, a styrene based monomer (for example, styrenevinyltoluene, α-methylstyrene, etc.), a vinyl derivative (for example, vinyl chloride, vinylidene chloride, vinyl acetate, isopropenyl acetate, etc.), an unsaturated dibasic acid (for example, maleic acid, fumaric acid, etc.) or the like.

Also, it is desirable that the binder contains a compound having an ester bond, which is represented by the following formula (1). Though the monomer represented by the formula (1) is not particularly limited, a monomer wherein R1 is H or CH₃ is desirable. R2 is preferably a divalent hydrocarbon group. For example, it is suitable that the divalent hydrocarbon group is an alkylene group having from 4 to 100 carbon atoms, preferably an alkylene group having from 6 to 50 carbon atoms, and more preferably an alkylene group having from 8 to 15 carbon atoms. This alkylene group may be either linear or branched. Also, a part of the alkylene group may be substituted with a halogen (for example, fluorine, chlorine, iodine, etc.), nitrogen, phosphorus, an aromatic ring, a cycloalkane having from 3 to 10 carbon atoms or the like. In the formula (1), it is suitable that R2 is a single alkylene group having from 2 to 6 carbon atoms, and preferably a single alkylene group having from 2 to 4 carbon atoms. Also, R2 may be a group in which alkylene groups are linked to each other via an ether bond and/or an ester bond. Here, the alkylene group may be substituted with a halogen (for example, fluorine, chlorine, bromine, iodine, etc.), nitrogen, phosphorus, an aromatic ring, a cycloalkane having from 3 to 10 carbon atoms or the like. Specific examples thereof include monoethylene glycol monomethacrylate and triethylene glycol monoacrylate.

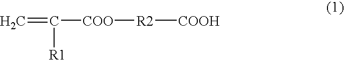

Also, in the polyacrylonitrile based resin which is a modified product of the foregoing copolymer and which is a (meth)acrylate copolymer, the “modified product” means a material obtained upon being modified with an alcoholic hydroxyl group, a carboxyl group, etc. The alcoholic hydroxyl group or carboxyl group may be introduced by substituting other group with an alcoholic hydroxyl group, a carboxyl group, etc., or copolymerizing a monomer containing an alcoholic hydroxyl group, a carboxyl group, etc.

Also, as the (meth)acrylate, there are exemplified those described above.

The foregoing polyacrylonitrile based resin is used singly or in combinations of two or more kinds thereof.

Next, the polyvinylidene fluoride based resin is described.

The polyvinylidene fluoride based resin is preferably a homopolymer of vinylidene fluoride, a copolymer of vinylidene fluoride with other monomer, or a modified product of the foregoing copolymer. Of these, a homopolymer of vinylidene fluoride is more preferable.

Examples of the copolymer of vinylidene fluoride with other monomer include a vinylidene fluoride-hexafluoropropylene copolymer, a vinylidene fluoride-tetrafluoroethylene copolymer, a vinylidene fluoride-chlorotrifluoroethylene copolymer, a vinylidene fluoride-hexafluoropropylene-tetrafluoroethylene copolymer, and a copolymer obtained by further copolymerizing the above-exemplified copolymer with other ethylenically unsaturated monomer. More specifically, examples of the copolymerizable ethylenically unsaturated monomer include acrylic esters, methacrylic esters, vinyl acetate, acrylonitrile, acrylic acid, methacrylic acid, maleic anhydride, butadiene, styrene, N-vinylpyrrolidone, N-vinylpyridine, glycidyl methacrylate, hydroxyethyl methacrylate and methyl vinyl ether.

Also, in the polyvinylidene fluoride based resin which is a modified product of the foregoing copolymer, the “modified product” means a material obtained upon being modified with an alcoholic hydroxyl group, a carboxyl group, etc. The alcoholic hydroxyl group or carboxyl group may be introduced by substituting other group with an alcoholic hydroxyl group, a carboxyl group, etc., or copolymerizing a monomer containing an alcoholic hydroxyl group, a carboxyl group, etc.

In an embodiment according to the present invention, as the binder, a material other than those described above may be used jointly. Examples of the material which may be used jointly include a styrene-butadiene rubber, carboxymethyl cellulose and polytetrafluoroethylene.

In an embodiment according to the present invention, a content of the polyacrylonitrile based resin or a total content of the polyacrylonitrile based resin and the polyvinylidene fluoride based resin is preferably from 0.1 to 10% on the basis of the whole mass of the negative electrode mixture. In the case of mixing the polyacrylonitrile based resin and the polyvinylidene fluoride based resin, when a blending ratio of the polyvinylidene fluoride based resin is too high, there is a concern that adhesion to the electrode is not obtainable. When it is needed to secure flexibility, or when the binder is used for a gel polymer battery to enhance adhesion to the gel, there may be the case where a polyvinylidene fluoride based resin is mixed. A ratio of the polyacrylonitrile based resin to the polyvinylidene fluoride based resin in the binder component is preferably from 100/0 to 10/90, and more preferably from 100/0 to 30/70 in terms of a mass ratio. A blending ratio of the binder in the negative electrode mixture is preferably from 1 to 7% by mass, and more preferably from 1.5 to 5% by mass. When the blending ratio of the binder is too low, it becomes difficult to obtain adhesion to the electrode, whereas when it is too high, there is a concern that inhibition of Li ion insertion at the time of charge or a lowering of the capacity is caused.

One embodiment is hereunder described in detail with reference to the accompanying drawings.

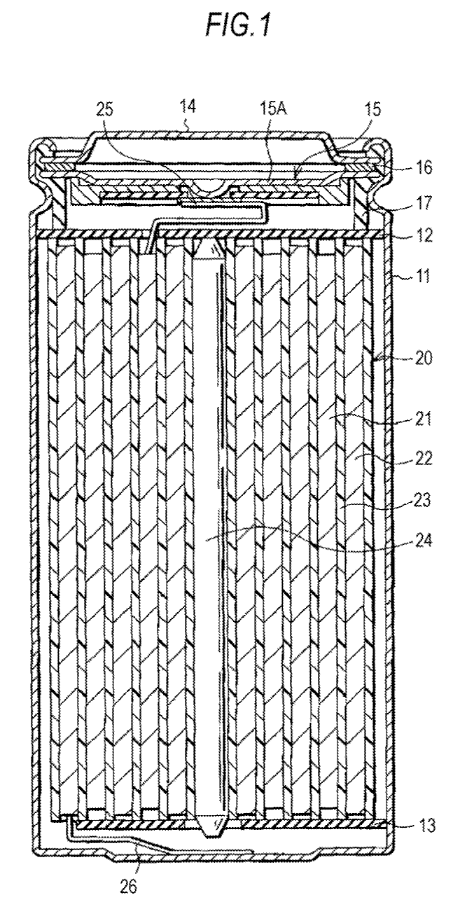

FIG. 1 shows a sectional view of a secondary battery according to the embodiment. This secondary battery is of a so-called cylinder type and has a wound electrode body 20 having a strip-shaped positive electrode 21 and a strip-shaped negative electrode 22 wound therein via a separator 23 in the inside of a substantially hollow columnar battery can 11. The battery can 11 is constituted of, for example, iron (Fe) plated with nickel (Ni), and one end thereof is closed, with the other end being opened. A pair of insulating plates 12 and 13 is disposed so as to vertically interpose the wound electrode body 20 therebetween relative to the wound peripheral surface thereof in the inside of the battery can 11.

In the open end of the battery can 11, a battery lid 14 and a safety valve mechanism 15 and a positive temperature coefficient element (PTC element) 16 each provided on the inside of this battery lid 14 are installed by caulking via a gasket 17, and the inside of the battery can 11 is hermetically sealed. The battery lid 14 is made of, for example, a material the same as that in the battery can 11. The safety valve mechanism 15 is electrically connected to the battery lid 14 via the positive temperature coefficient element 16, and in the case where the internal pressure reaches a fixed value or more due to an internal short circuit or heating from the outside or the like, a disc plate 15A is reversed, whereby electrical connection between the battery lid 14 and the wound electrode body 20 is disconnected. When the temperature increases, the positive temperature coefficient element 16 controls the current due to an increase of a resistance value, thereby preventing abnormal heat generation to be caused due to a large current. The gasket 17 is made of, for example, an insulating material, and asphalt is coated on the surface thereof.

For example, a center pin 24 is inserted on the center of the wound electrode body 20. In the wound electrode body 20, a positive electrode lead 25 made of aluminum (Al) or the like is connected to the positive electrode 21; and a negative electrode lead 26 made of nickel or the like is connected to the negative electrode 22. The positive electrode lead 25 is electrically connected to the battery lid 14 by means of welding with the safety valve mechanism 15; and the negative electrode lead 26 is electrically connected to the battery can 11 by means of welding.

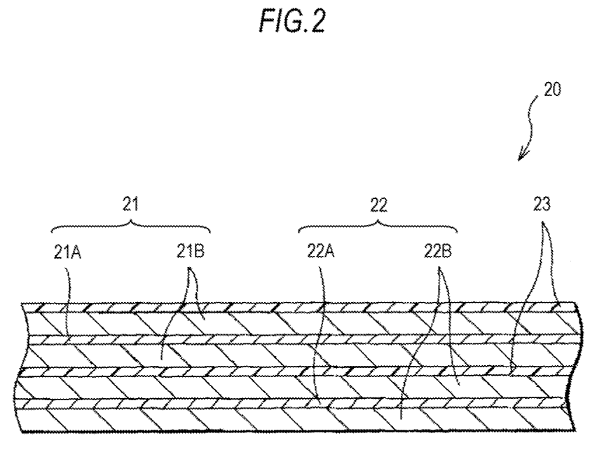

FIG. 2 shows enlargedly a part of the wound electrode body 20 shown in FIG. 1.

The positive electrode 21 has, for example, a structure in which a positive electrode active material layer 21B is provided on the both surfaces of a positive electrode collector 21A having a pair of opposing surfaces. While illustration is omitted, the positive electrode active material layer 21B may be provided on only one surface of the positive electrode collector 21A. The positive electrode collector 21A is constituted of a metal foil, for example, an aluminum foil, a nickel foil, a stainless steel foil, etc.

The positive electrode active material layer 21B is, for example, constituted so as to contain, as a positive electrode active material, one or two or more kinds of positive electrode materials capable of intercalating and deintercalating lithium as an electrode reactant. Examples of the positive electrode material capable of intercalating and deintercalating lithium include lithium-containing compounds such as lithium oxide, lithium sulfide, lithium-containing intercalation compounds and lithium phosphate compounds. Of these, complex oxides containing lithium and a transition metal element and phosphate compounds containing lithium and a transition metal element are preferable; and compounds containing, as a transition metal element, at least one member among cobalt (Co), nickel, manganese (Mn), iron, aluminum, vanadium (V) and titanium (Ti) are especially preferable. A chemical formula thereof is represented by, for example, LiₓMIO₂ or Li_{y}MIIPO₄. In the formulae, each of MI and MII includes at least one member of transition metal elements; and each of x and y values varies depending upon the charge and discharge state of the battery and is usually satisfied with the relationships of 0.05≦x≦1.10 and 0.05≦y≦1.10, respectively.

Specific examples of the complex oxide containing lithium and a transition metal element include a lithium cobalt complex oxide (LiₓCoO₂), a lithium nickel complex oxide (LiₓNiO₂), a lithium nickel cobalt complex oxide (LiₓNi_{1-z}CO_{z}O₂ (z<1)), a lithium nickel cobalt manganese complex oxide (LiₓNi_{(1-v-w)}COᵥMn_{w}O₂ ((v+w)<1)) and a lithium manganese complex oxide having a spinel type structure (LiMn₂O₄). Also, specific examples of the phosphate compound containing lithium and a transition metal element include a lithium iron phosphate compound (LiFePO₄) and a lithium iron manganese phosphate compound (LiFe₁₋ᵤMnᵤPO₄ (u<1)).

As the positive electrode material capable of intercalating and deintercalating lithium, other metal compounds or polymer materials are exemplified. Examples of other metal compound include oxides (for example, titanium oxide, vanadium oxide, manganese dioxide, etc.) and disulfides (for example, titanium disulfide, molybdenum disulfide, etc.). Examples of the polymer material include polyaniline and polythiophene.

The positive electrode active material layer 21B may contain a conductive agent as the need arises. Examples of the conductive agent include carbon materials such as graphite, carbon black and ketjen black, and these materials are used singly or in admixture of two or more kinds thereof. Also, in addition to the carbon material, a metal material or a conductive polymer material or the like may be used so far as it is a material having conductivity.

The negative electrode 22 has, for example, a configuration in which a negative electrode active material layer 22B is provided on the both surfaces of a negative electrode collector 22A having a pair of opposing surfaces. While illustration is omitted, the negative electrode active material layer 22B may be provided on only one surface of the negative electrode collector 22A. The negative electrode collector 22A is constituted of a metal foil, for example, a copper foil, a nickel foil, a stainless steel foil, etc.

The negative electrode active material layer 22B is, for example, constituted so as to contain, as a negative electrode active material, one or two or more kinds of negative electrode materials capable of intercalating and deintercalating lithium as an electrode reactant and may contain, for example, the same conductive agent as in the positive electrode active material layer 21B according to need.

Examples of the negative electrode active material capable of intercalating and deintercalating lithium include carbon based materials, for example, graphite, hardly graphitized carbon, easily graphitized carbon, etc. Such a carbon material is preferable because a change in the crystal structure to be generated at the time of charge and discharge is very little, a high charge and discharge capacity is obtainable, and a favorable charge and discharge cycle characteristic is obtainable. In particular, graphite is preferable because it has a large electrochemical equivalent and is able to obtain a high energy density.

As the graphite, one having a true density of 2.10 g/cm³ or more is preferable, and one having a true density of 2.18 g/cm³ or more is more preferable. In order to obtain such a true density, it is necessary that a thickness of a crystallite on the C-axis on the (002) plane is 14.0 nm or more. Also, a lattice spacing of the (002) plane of the graphite is preferably less than 0.340 nm, and more preferably in the range of 0.335 nm or more and not more than 0.337 nm. The graphite may be either natural graphite or artificial graphite.

As the hardly graphitized carbon, one which has a lattice spacing of the (002) plane of 0.37 nm or more and a true density of less than 1.70 g/cm³ and which does not show an exothermic peak at 700° C. or higher in differential thermal analysis (DTA) in air is preferable.

As the negative electrode material capable of intercalating and deintercalating lithium, a negative electrode material which is capable of intercalating and deintercalating lithium and which contains, as a constitutional element, at least one member of a metal element and a semi-metal element is also exemplified. This is because by using such a negative electrode material, a high energy density is obtainable. This negative electrode material may be a single substance, an alloy or a compound of a metal element or a semi-metal element. Also, one having a single kind or plural kinds of a phase in at least a part thereof may be used. In the embodiment, the alloy includes, in addition to alloys composed of two or more kinds of a metal element, alloys containing one or more kinds of a metal element and one or more kinds of a semi-metal element. Also, the alloy may contain a non-metal element. Examples of its texture include a solid solution, a eutectic (eutectic mixture), an intermetallic compound and one in which two or more kinds thereof coexist.

Examples of the metal element or semi-metal element constituting the negative electrode material include magnesium (Mg), boron (B), aluminum, gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd) and platinum (Pt), each of which is capable of forming an alloy together with lithium. These may be crystalline or amorphous.

Above all, as the negative electrode material, ones containing, as a constitutional element, a metal element or a semi-metal element belonging to the Group 4B in the short form of the periodic table are preferable, and ones containing, as a constitutional element, at least one of silicon and tin are especially preferable. This is because silicon and tin have large ability for intercalating and deintercalating lithium and are able to obtain a high energy density.

Examples of alloys of tin include alloys containing, as a second constitutional element other than tin, at least one member selected from the group consisting of silicon, nickel, copper (Cu), iron, cobalt, manganese, zinc, indium, silver, titanium (Ti), germanium, bismuth, antimony (Sb) and chromium (Cr). Examples of alloys of silicon include alloys containing, as a second constitutional element other than silicon, at least one member selected from the group consisting of tin, nickel, copper, iron, cobalt, manganese, zinc, indium, silver, titanium, germanium, bismuth, antimony and chromium.

Examples of compounds of tin or compounds of silicon include compounds containing oxygen (O) or carbon (C), and these compounds may contain, in addition to tin or silicon, the foregoing second constitutional element.

The separator 23 isolates the positive electrode 21 and the negative electrode 22 from each other, prevents a short circuit of current to be caused due to contact of the both electrodes from occurring and allows a lithium ion to pass therethrough. The separator 23 is constituted of, for example, a porous membrane made of a synthetic resin such as polytetrafluoroethylene, polypropylene and polyethylene or a porous membrane made of an inorganic material such as a ceramic-made nonwoven fabric. The separator 23 may also have a porous membrane structure in which two or more kinds of these porous membranes are laminated. Above all, a polyolefin-made porous membrane is preferable because it is excellent in an effect for preventing a short circuit from occurring and is able to contrive to enhance safety of the battery due to a shutdown effect. In particular, polyethylene is preferable as a material which constitutes the separator 23 because it is able to obtain a shutdown effect within a temperature range of 100° C. or higher and not higher than 160° C. and is excellent in electrochemical stability. Also, polypropylene is preferable. Besides, a resin may be used upon being copolymerized or blended with polyethylene or polypropylene so far as it is provided with chemical stability.

An electrolytic solution is impregnated in the separator 23. The electrolytic solution contains, for example, a solvent and an electrolyte salt dissolved in this solvent.

Examples of the solvent include 4-fluoro-1,3-dioxolan-2-one, ethylene carbonate, propylene carbonate, butylene carbonate, vinylene carbonate, dimethyl carbonate, diethyl carbonate, ethyl methyl carbonate, γ-butyrolactone, γ-valerolactone, 1,2-dimethoxyethane, tetrahydrofuran, 2-methyltetrahydrofuran, 1,3-dioxolan, 4-methyl-1,3-dioxolan, methyl acetate, methyl propionate, ethyl propionate, acetonitrile, glutaronitrile, adiponitrile, methoxyacetonitrile, 3-methoxypropyronitrile, N,N-dimethylformamide, N-methylpyrrolidinone, N-methyloxazolidinone, nitromethane, nitroethane, sulfolane, dimethyl sulfoxide, trimethyl phosphate, triethyl phosphate and ethylene sulfide. Above all, ethylene carbonate, propylene carbonate, vinylene carbonate, dimethyl carbonate, ethyl methyl carbonate and ethylene sulfide are preferable because excellent charge and discharge capacity characteristic and charge and discharge cycle characteristic are obtainable. In addition to the foregoing, the solvent may contain an ambient temperature molten salt such as bis(trimethylfluorosulfonyl)imide trimethylhexylammonium.

As the electrolyte salt, any one kind or two or more kinds of materials, for example, lithium hexafluorophosphate (LiPF₆), lithium bis(pentafluoroethanesulfonyl)imide (Li(C₂F₅SO₂)₂N), lithium perchlorate (LiClO₄), lithium hexafluoroarsenate (LiAsF₆), lithium tetrafluoroborate (LiBF₄), lithium trifluoromethanesulfonate (LiSO₃CF₃), lithium bis(trifluoromethanesulfonyl)imide (Li(CF₃SO₂)₂N), tris(trifluoromethanesulfonyl)methyl lithium (LiC(SO₂CF₃)₃), lithium chloride (LiCl) and lithium bromide (LiBr) are useful.

This secondary battery may be, for example, manufactured in the following manner.

First of all, a positive electrode active material, a conductive agent and a binder are mixed to prepare a positive electrode mixture. This positive electrode mixture is dispersed in a solvent such as N-methyl-2-pyrrolidone (NMP) to form a pasty positive electrode mixture slurry. Subsequently, this positive electrode mixture slurry is coated on the positive electrode collector 21A, and the solvent is then volatilized. Furthermore, the resultant is compression molded by a roll press or the like to form the positive electrode active material layer 21B. There is thus prepared the positive electrode 21.

Also, a negative electrode active material, a binder containing at least a polyacrylonitrile based resin and a functional polymer according to the embodiment of the present invention, such as polyvinylpyrrolidone, are mixed to prepare a negative electrode mixture. This negative electrode mixture is dispersed in a solvent such as N-methyl-2-pyrrolidone to form a pasty negative electrode mixture slurry. In this way, in the case of using a binder containing a polyacrylonitrile based resin, in the slurry containing the functional polymer according to the embodiment of the present invention, stability with time of the slurry is enhanced, and coagulation of the slurry and generation of a sediment may be significantly delayed by the functional polymer according to the embodiment of the present invention so that labor saving is attainable.

Subsequently, this negative electrode mixture slurry is coated on the negative electrode collector 22A, and the solvent is then dried. Thereafter, the resultant is compression molded by a roll press or the like to form the negative electrode active material layer 22B. There is thus prepared the negative electrode 22.

Subsequently, the positive electrode lead 25 is installed in the positive electrode collector 21A by means of welding or the like, and the negative electrode lead 26 is also installed in the negative electrode collector 22A by means of welding or the like. Thereafter, the positive electrode 21 and the negative electrode 22 are wound via the separator 23; a tip end of the positive electrode lead 25 is welded with the safety valve mechanism 15; and a tip end of the negative electrode lead 26 is welded with the battery can 11. The wound positive electrode 21 and negative electrode 22 are interposed between a pair of the insulating plates 12 and 13 and housed in the inside of the battery can 11. After housing the positive electrode 21 and the negative electrode 22 in the inside of the battery can 11, an electrolytic solution is injected into the inside of the battery can 11 and impregnated in the separator 23. Thereafter, the battery lid 14, the safety valve mechanism 15 and the positive temperature coefficient device 16 are fixed to the open end of the battery can 11 upon being caulked via the gasket 17. There is thus completed the secondary battery shown in FIG. 1.

In this secondary battery, when charged, for example, a lithium ion is deintercalated from the positive electrode active material layer 21B and intercalated in the negative electrode active material layer 22B via the electrolytic solution. Also, when discharged, for example, a lithium ion is deintercalated from the negative electrode active material layer 22B and intercalated in the positive electrode active material layer 21B via the electrolytic solution.

### EXAMPLES

Specific working examples are hereunder described in detail.

### Preparation of Slurry for Negative Electrode

### Examples 1 to 12 and Example 15

Natural or artificial graphite as a negative electrode active material made of a carbon based material (a specific surface area (SA) of which is shown in Table 1), PAN as a binder and PVP (polyvinylpyrrolidone), PEO (polyethylene oxide) or PAA (polyacrylic acid) which is the functional polymer according to the embodiment of the present invention as a polymer A were uniformly mixed, respectively using NMP as a solvent, thereby obtaining a slurry for negative electrode. Each of the addition amounts shown in Table 1 is a proportion to the negative electrode mixture.

### Examples 13 to 14

Natural graphite as a negative electrode active material made of a carbon based material (a specific surface area (SA) of which is shown in Table 1), PAN as a binder, PVP as a polymer A and PVDF as a polymer B were uniformly mixed, respectively using NMP as a solvent, thereby obtaining a slurry for negative electrode. Each of the addition amounts shown in Table 1 is a proportion to the negative electrode mixture.

The thus obtained slurries for negative electrode were evaluated as follows.

(Stability)

100 mL of the slurry was collected in a 100-cc plastic cup, and a degree of sedimentation after elapsing 10 hours was confirmed.

A: No sediment was formed.

B: The viscosity slightly increased.

C: A hard sediment was formed in the bottom of the container.

(Adhesion)

The slurry was coated on a copper foil and dried at 120° C. by a hot air dryer; and a pressure sensitive adhesive double coated tape was bonded onto a negative electrode active material layer and cut out together with the copper foil to prepare a specimen, which was then subjected to a peel test at 180° C. The peel test was carried out in the following manner. That is, the other surface of the pressure sensitive adhesive double coated tape of the specimen is fixed by a SUS plate, and the negative electrode active material layer is taken off to the half, thereby achieving a tensile test (at 180° C.).

A: 10 mN/mm or more

B: Less than 10 mN/mm

C: The measurement could not be carried out. That is, in taking off the pressure sensitive adhesive double coated tape from the electrode, the both were taken off together so that the measurement could not be carried out (0 mN/mm).

<Preparation of Slurry for Positive Electrode>

Lithium cobaltate as a positive electrode active material, carbon black as a conductive agent, PVDF as a binder and NMP as a solvent were uniformly mixed, respectively to obtain a slurry for positive electrode.

<Preparation of Negative Electrode>

The obtained slurry was uniformly coated on the both surfaces of a negative electrode collector made of a copper foil having a thickness of 12 μm, dried and then compression molded by a roll press to form a negative electrode mixture layer. There was thus prepared a negative electrode. Thereafter, a negative electrode terminal made of nickel was installed in the negative electrode.

<Preparation of Positive Electrode>

The obtained slurry was uniformly coated on the both surfaces of a positive electrode collector made of an aluminum foil having a thickness of 15 μm, dried and then compression molded by a roll press to form a positive electrode mixture layer. There was thus prepared a positive electrode. Thereafter, a positive electrode terminal made of aluminum was installed in the positive electrode.

<Preparation of Battery>

The positive electrode and the negative electrode were laminated via a separator made of a microporous polyethylene film having a thickness of 22 μm. The resulting laminate was wound around the circumference of a center pin having a diameter of 3.2 mm, thereby preparing a wound electrode body. Subsequently, the wound electrode body was interposed between a pair of insulating plates; not only a negative electrode lead was welded with a battery can, but a positive electrode lead was welded with a safety valve mechanism; and the wound electrode body was then housed in the inside of the nickel-plated iron-made battery can. Subsequently, an electrolytic solution was injected into the inside of the battery can, and a battery lid was caulked with the battery can via a gasket, thereby preparing a secondary battery of a cylinder type.

On that occasion, a solution prepared by dissolving, as an electrolyte salt, lithium hexafluorophosphate in a proportion of 1.0 mole/kg in a mixed solvent of vinylene carbonate (VC), ethylene carbonate (EC), fluoroethylene carbonate (FEC), diethyl carbonate (DEC) and propylene carbonate (PC) in a proportion of 1/30/10/49/10 was used as the electrolytic solution.

Each of the prepared secondary batteries was subjected to charge and discharge and examined with respect to a discharge capacity retention rate. On that occasion, charge was performed at a constant current of 0.7 C until a battery voltage reached 4.2 V and then performed at a constant voltage of 4.2 V until a total charge time reached 4 hours; and discharge was performed at a constant current of 0.5 C until a battery voltage reached 3.0 V. The term “1 C” as referred to herein represents a current value at which a theoretical capacity is completely discharged within one hour. A ratio of the discharge capacity at the 100th cycle to the discharge capacity at the first cycle, namely [{(discharge capacity at the 100th cycle)/(discharge capacity at the first cycle)}×100(%)] was defined for the discharge capacity retention rate, and each of them was expressed in terms of a relative ratio. The results are shown in Table 1.

### Comparative Examples 1 to 13

Slurries, electrodes and batteries were prepared in the same manner as in Examples 1 to 15, except for and using each of negative electrodes shown in Table 1 while using the same negative electrode as in Examples 1 to 15, and the evaluation was made in the same manner as described above. The results are shown in Table 1. PVDF in Comparative Examples 2 to 4, PTFE (polytetrafluoroethylene) in Comparative Example 5 and PVC (polyvinyl chloride) in Comparative 6, all of which were used as the polymer B, do not have the functions of the functional polymer according to the embodiment of the present invention. Also, PEO (polyethylene oxide) in Comparative Examples 9 and 10, CTAB (cetyl trimethyl ammonium bromide) in Comparative Example 11, SDS (sodium dodecyl sulfate) in Comparative Example 12 and VP (monomer of PVP) in Comparative Example 13, all of which were used as the polymer A, have a function of suppressing an intermolecular interaction between cyano groups; however, their molecular weights do not reach the lower limit of the functional polymer according to the embodiment of the present invention, and their functions are insufficient. Also, in Comparative Example 8, CMC (carboxymethyl cellulose) and SBR were used in amounts shown in Table 1 as the binder in place of PAN.

TABLE 1

| | | | | Polymer A | | | Polymer B | | | | | |
|---|---|---|---|---|---|---|---|---|---|---|---|---|
| | Carbon based material | | PAN | | Mass | | | Mass | | | | |
| | | SA | Addition | | average | Addition | | average | Addition | | | Cycle |
| | | m²/ | amount | | molecular | amount | | molecular | amount | | | charac- |
| | Kind | g | % | Kind | weight | % | Kind | weight | % | Stability | Adhesion | teristic |
| Example 1 | Natural graphite | 3 | 3.5 | PVP | 10000 | 0.5 | | | | B | A | 90.8 |
| Example 2 | Natural graphite | 3 | 3.5 | PVP | 10000 | 1.0 | | | | A | A | 90.3 |
| Example 3 | Natural graphite | 3 | 3.5 | PVP | 24000 | 1.0 | | | | A | A | 90.4 |
| Example 4 | Natural graphite | 3 | 3.5 | PVP | 360000 | 0.5 | | | | A | A | 91.2 |
| Example 5 | Natural graphite | 3 | 2.0 | PVP | 10000 | 0.5 | | | | B | A | 92.2 |
| Example 6 | Natural graphite | 3 | 2.0 | PVP | 10000 | 1.0 | | | | A | A | 91.9 |
| Example 7 | Natural graphite | 3 | 2.0 | PVP | 24000 | 1.0 | | | | A | A | 91.7 |
| Example 8 | Natural graphite | 3 | 2.0 | PVP | 360000 | 0.5 | | | | A | A | 92.2 |
| Example 9 | Natural graphite | 3 | 3.5 | PEO | 50000 | 1.0 | | | | A | A | 93.2 |
| Example 10 | Natural graphite | 3 | 2.0 | PEO | 50000 | 1.0 | | | | A | A | 93.5 |
| Example 11 | Natural graphite | 3 | 3.5 | PAA | 24000 | 1.0 | | | | A | A | 90.9 |
| Example 12 | Natural graphite | 3 | 2.0 | PAA | 24000 | 1.0 | | | | A | A | 91.2 |
| Example 13 | Natural graphite | 3 | 1.0 | PVP | 360000 | 0.1 | PVDF | 300000 | 2.5 | A | B | 92.2 |
| Example 14 | Natural graphite | 3 | 2.5 | PVP | 360000 | 0.5 | PVDF | 300000 | 1.0 | A | A | 93.6 |
| Example 15 | Artificial graphite | 0.8 | 1.5 | PVP | 360000 | 1.0 | | | | A | A | 94.3 |
| Comparative | Natural graphite | 3 | 3.5 | — | — | — | | | | C | A | 85.3 |
| Example 1 | | | | | | | | | | | | |
| Comparative | Natural graphite | 3 | 3.0 | — | — | — | PVDF | 300000 | 0.5 | C | A | 85.3 |
| Example 2 | | | | | | | | | | | | |
| Comparative | Natural graphite | 3 | 1.0 | — | — | — | PVDF | 300000 | 2.5 | C | B | 84.9 |
| Example 3 | | | | | | | | | | | | |
| Comparative | Natural graphite | 3 | 0.0 | — | — | — | PVDF | 300000 | 3.5 | A | C | 80.2 |
| Example 4 | | | | | | | | | | | | |
| Comparative | Natural graphite | 3 | 3.0 | — | — | — | PTFE | 200000 | 0.5 | C | A | 58.2 |
| Example 5 | | | | | | | | | | | | |
| Comparative | Natural graphite | 3 | 3.0 | — | — | — | PVC | 250000 | 0.5 | C | A | 78.2 |
| Example 6 | | | | | | | | | | | | |
| Comparative | Artificial graphite | 0.8 | 1.5 | — | — | — | | | | C | A | 86.8 |
| Example 7 | | | | | | | | | | | | |
| Comparative | Natural graphite | 3 | CMC/SBR = | | — | — | | | | A | C | 79.8 |
| Example 8 | | | 1.5/1.5 | | | | | | | | | |
| Comparative | Natural graphite | 3 | 3.5 | PEO | 600 | 1.0 | | | | C | A | 85.6 |
| Example 9 | | | | | | | | | | | | |
| Comparative | Natural graphite | 3 | 2.0 | PEO | 600 | 1.0 | | | | C | A | 86.9 |
| Example 10 | | | | | | | | | | | | |
| Comparative | Natural graphite | 3 | 3.5 | CTAB | 364 | 1.0 | | | | C | A | 86.0 |
| Example 11 | | | | | | | | | | | | |
| Comparative | Natural graphite | 3 | 3.5 | SDS | 288 | 1.0 | | | | C | A | 85.3 |
| Example 12 | | | | | | | | | | | | |
| Comparative | Natural graphite | 3 | 3.5 | VP | 111 | 0.5 | | | | C | A | 87.0 |
| Example 13 | | | | | | | | | | | | |

It is noted from the foregoing table that in Examples 1 to 15, by adding the functional polymer according to the embodiment of the present invention to the slurry, coagulation derived from PAN is suppressed, and both stability of the coating material and adhesion of the negative electrode active material layer to the negative electrode collector may be made compatible with each other; whereas in Comparative Examples 1 to 13 which do not meet the requirements of the present invention, the both properties may not be made compatible with each other. In Examples 1 to 15, PAN exists uniformly, and binding properties of PAN may be made the best; and therefore, even when a natural graphite based material having a relatively large specific surface area but having a high capacity is used, the adhesion to the electrode may be kept satisfactory, and the capacity retention rate after cycling is improved. Also, when an artificial graphite based material having a small specific surface area is used, the amount of the binder may be reduced, and therefore, it is possible to realize a high capacity as an electrode.

Also, in the foregoing embodiments and working examples, while the secondary battery of a cylinder type having a wound structure has been specifically described, the embodiment is similarly applicable to secondary batteries of an elliptical type or polygonal type having a wound structure or secondary batteries having other shape such as those in which a positive electrode and a negative electrode are folded, or plural positive electrodes and negative electrodes are laminated. In addition, the present invention is similarly applicable to secondary batteries having other shape, for example, a coin type, a button type, a rectangular type, a laminated film type, etc.

Also, in the foregoing embodiments and working examples, while the case of using a liquid electrolytic solution has been described, a gel formed by holding an electrolytic solution on a holding material such as a polymer compound may be used. Examples of the polymer compound include polyacrylonitrile, polyvinylidene fluoride, a copolymer of polyvinylidene fluoride and polyhexafluoropropylene, polytetrafluoroethylene, polyhexafluoropropylene, polyethylene oxide, polypropylene oxide, polyphosphazene, polysiloxanes, polyvinyl acetate, polyvinyl alcohol, polymethyl methacrylate, polyacrylic acid, polymethacrylic acid, a styrene-butadiene rubber, a nitrile-butadiene rubber, polystyrene and polycarbonate. In particular, from the standpoint of electrochemical stability, polyacrylonitrile, polyvinylidene fluoride, polyhexafluoropropylene, polyethylene oxide and the like are preferable. Though a proportion of the polymer compound to the electrolytic solution varies depending upon its compatibility, in general, it is preferred to add the polymer compound in an amount corresponding to 5% by mass or more and not more than 50% by mass relative to the electrolytic solution.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A nonaqueous electrolyte secondary battery comprising:
a negative electrode including a negative electrode collector and a negative electrode mixture laminated thereon, wherein
the negative electrode mixture contains
a negative electrode active material including a carbon based material,
a binder including at least a polyacrylonitrile based resin, and
a polymer capable of suppressing an intermolecular interaction between cyano groups and imparting a steric hindrance.

2. The nonaqueous electrolyte secondary battery according to claim 1, wherein
the polymer has a mass average molecular weight ranging from 1,000 to 1,000,000.

3. The nonaqueous electrolyte secondary battery according to claim 1, wherein
the binder contains a polyacrylonitrile based resin, or a polyacrylonitrile based resin and a polyvinylidene fluoride based resin; and
a content of the polyacrylonitrile based resin or a total content of the polyacrylonitrile based resin and the polyvinylidene fluoride based resin ranges from 0.1 to 10% on the basis of the whole mass of the negative electrode mixture.

4. The nonaqueous electrolyte secondary battery according to claim 1, wherein
the binder has a ratio of the polyacrylonitrile based resin to the polyvinylidene fluoride based resin of from 100/0 to 10/90 in terms of a mass ratio.

5. The nonaqueous electrolyte secondary battery according to claim 3, wherein
the polyacrylonitrile based resin is a homopolymer of (meth)acrylonitrile, a copolymer of (meth)acrylonitrile with other monomer, or a resin which is a modified product of the copolymer and which is a (meth)acrylate copolymer.

6. The nonaqueous electrolyte secondary battery according to claim 3, wherein
the polyvinylidene fluoride based resin is a homopolymer of vinylidene fluoride, a copolymer of vinylidene fluoride with other monomer, or a modified product of the copolymer.

7. The nonaqueous electrolyte secondary battery according to claim 1, wherein
a total content of the polymer capable of suppressing an intermolecular interaction between cyano groups and imparting a steric hindrance is from 0.01 to 5% on the basis of the whole mass of the negative electrode mixture.

8. A negative electrode mixture comprising:
a negative electrode active material containing a carbon based material;
a binder containing at least a polyacrylonitrile based resin; and
a polymer capable of suppressing an intermolecular interaction between cyano groups and imparting a steric hindrance.

9. A negative electrode comprising:
a negative electrode collector and a negative electrode mixture laminated thereon, wherein
the negative electrode mixture contains
a negative electrode active material including a carbon based material,
a binder including at least a polyacrylonitrile based resin, and
a polymer capable of suppressing an intermolecular interaction between cyano groups and imparting a steric hindrance.

10. A method for manufacturing a negative electrode, the method comprising:
coating a negative electrode mixture slurry on a negative electrode collector, the slurry containing a negative electrode active material containing a carbon based material, a solvent, a binder containing at least a polyacrylonitrile based resin and a polymer, the polymer being capable of suppressing an intermolecular interaction between cyano groups and imparting a steric hindrance; and
after coating, removing the solvent of the negative electrode mixture slurry upon being evaporated.
